(19) United States
(12) Patent Application Publication
(10) Pub. No.: US 2014/0070918 A1
(43) Pub. Date: Mar. 13, 2014

(54) TRAIN CONTROL SYSTEM USING DRIVER'S BIOMETRIC INFORMATION

(71) Applicant: LSIS CO., LTD., Anyang-si (KR)

(72) Inventor: Jae Mun HAN, Incheon-si (KR)

(73) Assignee: LSIS CO., LTD., Anyang-si (KR)

(21) Appl. No.: 14/017,174

(22) Filed: Sep. 3, 2013

(30) Foreign Application Priority Data
Sep. 10, 2012 (KR) 10-2012-0099859

(51) Int. Cl. B60R 25/23

(52) U.S. Cl. CPC B60R 25/23
USPC 340/5.52

(57) ABSTRACT

A train control system is disclosed, the system including a biometric information input device configured to receive a driver's biometric information through a sensor and to transmit the driver's biometric information to a cab signal device, wherein the cab signal device compares the biometric information of a driver intending to operate a train with a pre-registered driver's biometric information to verify a relevant driver, and verification of a driver intending to operate a train is realized by biometric information, and unauthorized person's access can be fundamentally avoided because biometric information cannot be copied or leaked due to person's biometric information being intrinsic.

### CROSS-REFERENCE TO RELATED APPLICATION

Pursuant to 35 U.S.C. §119(a), this application claims the benefit of earlier date and right of priority to Korean Patent Application No. 10-2012-0099859, filed on Sep. 10, 2012, the contents of which is incorporated by reference herein in its entirety.

### BACKGROUND OF THE INVENTION

1. Field of the Invention

Exemplary aspects of the present disclosure relate to a train control system using driver's biometric information, and more particularly to a train control system using driver's biometric information configured to allow a train control system used for train operation to conveniently and accurately verify a driver.

2. Description of Related Art

Concomitant with development of technology, an operation speed of a train continuously increases to gradually increase the importance of a driver operating the train, it is impossible to emphasize too much the importance of a signal device controlling a high speed train, in view of the fact the train is used by many people.

A driver operating a train inputs in advance a pre-provided driver ID (Identification) and basic operation information to a signal device, and starts an operation of the train after a predetermined routine inspection. That is, a cab signal device goes through an initialization process during railway vehicles being inputted with an electric power, and during this time, driver information and operation information must be inputted to the cab signal device. In connection therewith, a conventional system is configured such that a driver inputs the operation information through a touch-type operation screen.

However, the cab signal device suffers from a disadvantage in that a verified driver information may be inputted by an unauthorized person having a bad intention, and there is no way to prevent the weakness once the driver information is leaked, exposed or tampered.

Another disadvantage is that, in a case a driver erroneously inputs the driver information by mistake, the cab signal device cannot determine compatibility (matching) of the driver information and can only check whether the information is within a data of an effective range, thereby creating a problem of completing an initialization process of the railway vehicles even by input of unauthorized information.

### SUMMARY OF THE INVENTION

Exemplary aspects of the present disclosure are to substantially solve at least the above problems and/or disadvantages and to provide at least the advantages as mentioned below. Thus, the present disclosure is directed to provide a train control system using driver's biometric information configured to more conveniently and accurately input driver information that must be inputted before operation of a train.

In one general aspect of the present disclosure, there is provided a train control system using driver's biometric information, comprising:
a driver interface device configured to input or output information necessary for train operation by interfacing with a driver through a display screen;
a cab signal device configured to control the train operation in association with the driver interface device and to maintain driver's biometric information registered with a biometric information database;
a biometric information input device configured to receive the driver's biometric information using a sensor and to transmit the driver's biometric information to the cab signal device, wherein the cab signal device compares the biometric information received from the biometric information input device with the registered driver's biometric information stored in the biometric information database to verify a relevant driver.

Preferably, but not necessarily, the biometric information may include information on at least any one of a person's fingerprints, and retinas.

Preferably, but not necessarily, the cab signal device may store the biometric information received from the biometric information input device in response to an operation mode, in the biometric information database as the relevant driver's biometric information.

Preferably, but not necessarily, the cab signal device may further include an operation information database configured to store the operation information, and processes the operation information stored in the operation information database as driver' operation information verified through the biometric information.

The train control system using driver's biometric information has an advantageous effect in that a driver's verification for train operation is realized by using a person's biometric information.

The train control system using driver's biometric information has another advantageous effect in that only a pre-registered driver can obtain verification for train operation because biometric information cannot be copied or leaked due to person's biometric information being intrinsic, whereby unauthorized person's access can be fundamentally avoided to prevent in advance the driver's information from being erroneously inputted by mistake.

### BRIEF DESCRIPTION OF THE DRAWINGS

FIG. 1 is a block diagram illustrating a train control system using driver's biometric information according to an exemplary embodiment of the present disclosure.

FIG. 2 is a flowchart illustrating a process of a driver starting a train operation according to the present disclosure.

FIG. 3 is a block diagram illustrating a procedure in which a cab signal device divides and processes inputted biometric information in response to a driver verification mode and a driver registration mode according to an exemplary embodiment of the present disclosure.

### DETAILED DESCRIPTION OF PREFERRED EMBODIMENTS

Now, exemplary embodiments of the present disclosure will be described in detail with reference to the accompanying drawings.

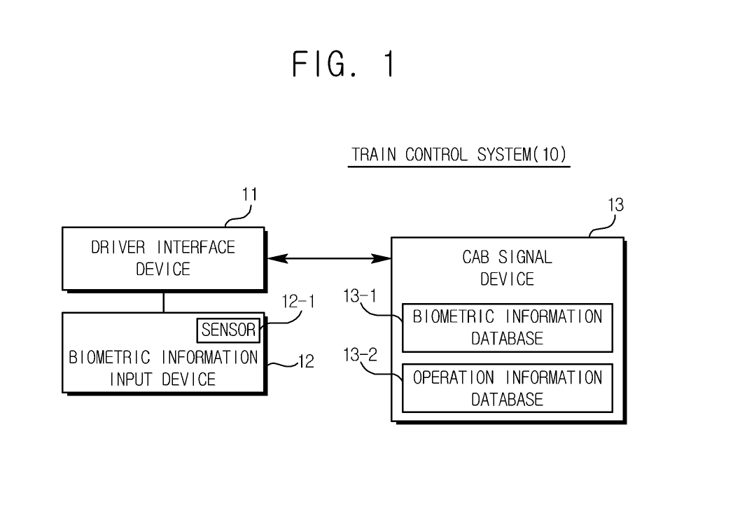

Referring to FIG. 1, a train control system (10) according to an exemplary embodiment of the present disclosure includes a driver interface device (11), a biometric information input device (12) and a cab signal device (13).

The driver interface device (11) functions to visually interface with a driver through a display screen such as an LCD (Liquid Crystal Display) module or an LED (Liquid Emitting Diode) module, receives from a driver information necessary for train operation such as driver information or operation information to transmit the information to the cab signal device (13), or output information necessary for train operation transmitted by the cab signal device (13) to the display screen.

Methods of receiving from the driver information necessary for train operation may be variably configured. For example, the driver interface device (11) may be disposed with a touch panel and a driver can input the information by a touch method.

The cab signal device (13), which is a device installed inside a train, controls the operation of the train in association with the driver interface device (11).

The cab signal device (13) may be variably configured as an ATP (Automatic Train Protection) or an ATC (Automatic Train Control) according to trans-receiving method or additional function of the train signal, and may perform various functions as necessary. For example, the cab signal device (13) may perform train operation-related functions of receiving information for each ground section by communicating with ground signal devices, detecting train speed, providing various types of operation information to a driver, controlling braking systems of the train, and storing operation information. Particularly, the cab signal device (13) may include a biometric information database (13-1) configured to store and maintain registered driver's biometric information.

The biometric information input device (12) functions to receive driver's biometric information receive through a sensor (12-1) capable of detecting biometric information and to transmit the biometric information to the cab signal device (13). The biometric information defines information capable of intrinsically identifying characteristics of each person, and to be more specific, includes a person's fingerprints, and/or retinas.

A fingerprint reader may be used as a sensor in case of the former, and a camera capable of photographing retinas may be used as a sensor in case of the latter. The sensor (12-1) of the biometric information input device (12) is preferably arranged at a location where a driver can easily input the biometric information. By way of example, the sensor (12-1) of the biometric information input device (12) may be installed at a front surface of a case forming a display screen of the driver interface device (11).

In a case a driver intending to operate a train inputs fingerprint information or retina information through the sensor (12-1) of the biometric information input device (12), the biometric information is transmitted to the cab signal device (13), where the cab signal device (13) compares the received biometric information with biometric information stored in a biometric information database (13-1) to verify a relevant driver.

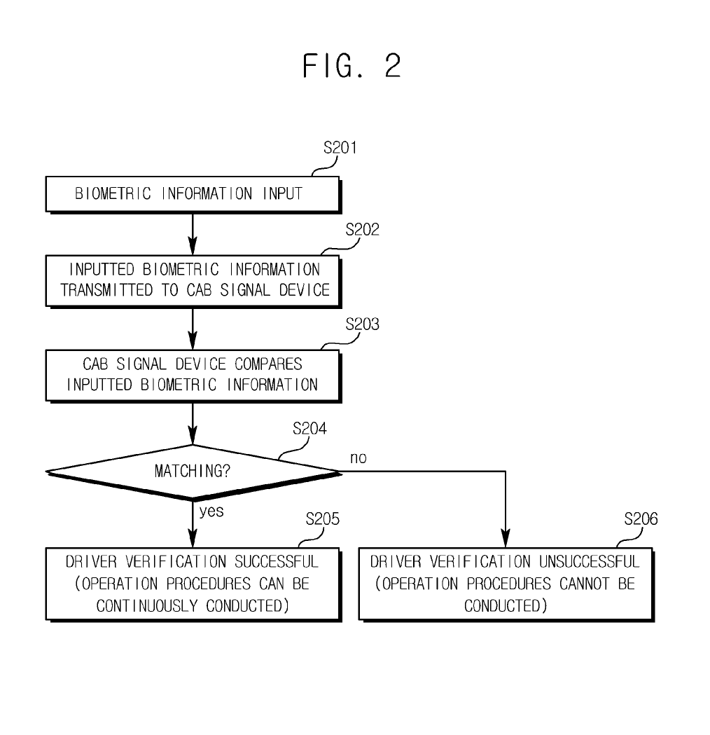

FIG. 2 is a flowchart illustrating a process of a driver starting a train operation according to the present disclosure, where the driver first inputs biometric information such as fingerprints or retinas through the sensor (12-1) of the biometric information input device (12) installed in the train control system (10) (S201).

The biometric information inputted through sensor (12-1) of the biometric information input device (12) is transmitted to the cap signal device (13) (S202), where the cap signal device (13) compares the received biometric information with the biometric information stored in the biometric information database (13-1) (S203).

As a result of comparison at step S203, if it is determined that the received biometric information matches the biometric information stored in the biometric information database (S204), verification of a relevant driver is successfully completed to allow a train to be operated (S205) because procedures for train operation such as input of operation information have been normally carried out.

However, as a result of comparison at step S203, if it is determined that the received biometric information fails to match the biometric information stored in the biometric information database, verification of a relevant driver is failed to disable procedures for train operation any more (S206).

The driver's biometric information stored in the biometric information database (13-1) of the cab signal device (13) may be registered in various methods. By way of example, the cab signal device (13) may receive the registered driver's biometric information by communicating with other devices outside of a train, or may receive the registered driver's biometric information from a relevant storing medium by being connected to a storing medium of digital information.

Furthermore, a driver's information may be registered at the biometric information input device (12) installed at the train control system (10). At this time, the cab signal device (13) may store the biometric information received from the biometric information input device (12) in response to operation mode in the biometric information database (13-1) as relevant driver's biometric information, or may verify the relevant driver.

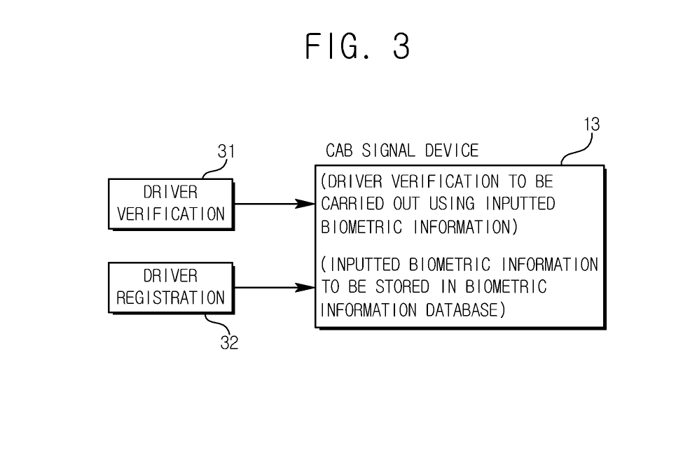

Now, referring to FIG. 3, a ‘driver verification’ menu (31) and a ‘driver registration’ menu (32) may be provided through the driver interface device (11). These operation mode menus (31, 32) may be displayed on a display screen to allow a driver to select the menus by a touch method, or by using a separate physical key.

In a case the driver verification menu (31) is selected, the cab signal device (13) may perform the driver verification using the biometric information inputted through the biometric information input device (12), as explained with reference to FIG. 2.

In a case the driver registration menu (32) is selected, the cab signal device (13) may store the biometric information inputted through the biometric information input device (12) in the biometric information database (13-1) as the registered driver's biometric information. Thereafter, the relevant driver may perform the driver verification using his or her biometric information.

It should be apparent that a separate verification is performed on registration qualification in order to prevent registration by everybody when the driver registration is performed. In the verification under this circumstance, a commonly used manager ID may be used, or a relevant manager's biometric information may be used in case of being with a manager.

The cab signal device (13) may further include an operation information database and the operation information stored in the operation information database (13-2) may be registered in various methods. By way of example, the registered driver's operation information may be received by communicating with other devices outside of the train. At this time, the cab signal device (13) may process the operation information stored in the operation information database (13-2) as driver' operation information verified through the biometric information.

Then, the driver can more conveniently and safely manage the operation information without the need of inputting post-verification operation information using the biometric information. If the operation information is different from the operation information stored in the operation information database (13-2), only procedure is to re-input the changed operation information.

Although exemplary embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims.

What is claimed is:

1. A train control system using driver's biometric information, comprising: a driver interface device configured to input or output information necessary for train operation by interfacing with a driver through a display screen; a cab signal device configured to control the train operation in association with the driver interface device and to maintain driver's biometric information registered with a biometric information database; a biometric information input device configured to receive the driver's biometric information using a sensor and to transmit the driver's biometric information to the cab signal device, wherein the cab signal device compares the biometric information received from the biometric information input device with the registered driver's biometric information stored in the biometric information database to verify a relevant driver.

2. The train control system of claim 1, wherein the biometric information includes information on at least any one of a person's fingerprints, and retinas.

3. The train control system of claim 1, wherein the cab signal device stores the biometric information received from the biometric information input device in response to an operation mode, in the biometric information database as the relevant driver's biometric information.

4. The train control system of claim 1, wherein the cab signal device further includes an operation information database configured to store the operation information, and processes the operation information stored in the operation information database as driver' operation information verified through the biometric information.
